(19) United States
(12) Patent Application Publication
(10) Pub. No.: US 2026/0033457 A1
(43) Pub. Date: Feb. 5, 2026

(54) Pet Paw Washing Arrangement

(71) Applicant: TAN GROW INC., BLUE ISLAND, IL (US)

(72) Inventor: Mengmeng MU, Ningbo (CN)

(21) Appl. No.: 19/358,391

(22) Filed: Oct. 14, 2025

Related U.S. Application Data
(63) Continuation-in-part of application No. 18/381,159, filed on Oct. 17, 2023.

(30) Foreign Application Priority Data
Sep. 28, 2025 (CN) 202511414728.3

(51) Int. Cl. A01K 13/00

(52) U.S. Cl. CPC A01K 13/001

(57) ABSTRACT

A pet paw washing arrangement includes a washing cup having a washing chamber, a water outlet communicated to the washing chamber, and an access opening; and a water storage container including a container body having a water chamber communicated to the water outlet to supply water to the washing chamber and a wastewater chamber communicated to the washing chamber, so that the pet paw washing arrangement is suitable for washing the pet paw at the door of the home or before the pet enters the vehicle, and the wastewater can be collected in the wastewater chamber.

### CROSS REFERENCE OF RELATED APPLICATION

This application is a non-provisional application that claims priority under 35U.S.C. §119 to China application number CN202511414728.3, filing date 09/28/2025; this application also is a Continuation-In-Part application that claims the benefit of priority under 35U.S.C.§120 to a non-provisional application, application number 18/381,159, filing date 10/17/2023, which is a non-provisional application that claims priority under 35U.S.C. §119 to China application number CN202211297927.7, filing date 10/21/2022, China application number CN202211308778.X, filing date 10/25/2022, and China application number CN202311284061.0, filing date 09/28/2023, wherein the entire content of which is expressly incorporated herein by reference.

### BACKGROUND OF THE PRESENT INVENTION

### FIELD OF INVENTION

The present invention relates to pet cleaning supplies, and more particularly to a pet paw washing arrangement which is able to wash pet paw and collect wastewater.

### DESCRIPTION OF RELATED ARTS

Pets such as cats and dogs often get their paws dirty when taken outdoors, and simple wiping cannot effectively remove the dust, mud, or debris. Conventional devices, such as a palm-attachable shower suffers from significant drawbacks, the palm-attachable shower is bulky, requires connection to a faucet, and delivers insufficient water pressure for cleaning paw crevices. Accordingly, these conventional solutions are not well suited for convenient, thorough, and portable paw cleaning.

In addition, in conventional paw washing devices, the wastewater generated after cleaning is usually discharged directly onto the ground, which easily leads to ground contamination and makes it inconvenient to wash the pet’s paws in locations such as at the entrance of a home.

Moreover, when the water pressure is relatively high during cleaning, the wastewater tends to splash in multiple directions and may even splash onto the user. Such problems not only create hygiene concerns and inconvenience but also reduce the user’s willingness to wash the pet’s paws frequently. As a result, the current devices are difficult to use effectively in daily scenarios such as immediately after outdoor walks, before entering the home, or prior to placing the pet into a vehicle.

### SUMMARY OF THE PRESENT INVENTION

The invention is advantageous in that it provides a pet paw washing arrangement, wherein a washing cup is connected with a water storage container so that each washing operation uses a continuous flow of clean water. This prevents reusing dirty water for subsequent paws, avoids cross-contamination, and ensures improved hygiene.

Another advantage of the present invention is to provide a pet paw washing arrangement, wherein a wastewater channel is connected to the washing cup, through which the used water flows back into the water storage container. In this manner, wastewater is collected instead of being discharged directly onto the ground, thereby avoiding ground contamination and maintaining a cleaner environment during paw cleaning.

Another advantage of the present invention is to provide a pet paw washing arrangement, wherein since the paw is placed inside the washing chamber during cleaning, the rinsing water is confined within the chamber and does not freely splash outward. Even under higher water pressure, water is prevented from splashing onto the user or the surrounding environment, keeping the cleaning process neat and comfortable.

Another advantage of the present invention is to provide a pet paw washing arrangement, wherein the water outlet is arranged on the surrounding wall of the washing cup and oriented toward the underside of the paw, so that water is directly flushed onto the paw pads and claw gaps where dirt tends to accumulate. Moreover, lateral inflow surrounds the paw, providing both bottom and side rinsing for a more comprehensive cleaning effect compared with bottom-only rinsing.

Another advantage of the present invention is to provide a pet paw washing arrangement, wherein flexible brush elements or silicone protrusions are disposed on the inner surface of the surrounding wall, positioned near the water outlet. In this arrangement, water jets cooperate with the brush elements to scrub and rinse the paw surface simultaneously, providing mechanical friction together with hydraulic flushing for more effective cleaning of paw pads and claw crevices.

Another advantage of the present invention is to provide a pet paw washing arrangement, wherein the washing cup is made of a flexible material. When holding the cup, the user can press or squeeze the surrounding wall to deform it, thereby guiding the internal brush elements into closer contact with the paw. This enables the user to perform holding, rinsing, and scrubbing actions with one hand, increasing convenience and cleaning efficiency.

Another advantage of the present invention is to provide a pet paw washing arrangement, wherein a connection component and a holding strip are arranged on opposite sides of the washing cup to define a holding channel and a holding passage for different fingers of the user. For example, the thumb may be inserted into the holding passage while other fingers are placed in the holding channel. This configuration creates a handle-like grip, distributes force evenly, prevents slipping, and reduces hand fatigue during extended use.

Another advantage of the present invention is to provide a pet paw washing arrangement, wherein the water storage container can be implemented as a flexible bag, portable tank, or pressurizable container, combined with an integrated water pump and battery-powered module. This makes the arrangement lightweight, portable, and suitable for various scenarios, such as at home entrances, in vehicles, or outdoors after walking the pet.

Another advantage of the present invention is to provide a pet paw washing arrangement, wherein an electric switch assembly, comprising a flexible cover and an electric switch member, is installed on the water guiding element and electrically connected to the water pump through wires arranged inside the feeding pipeline. The user can press the flexible cover with a finger of the same hand that holds the washing cup to switch on/off or adjust the water pump. Accordingly, the rinsing and control operations can be carried out with a single hand, while the other hand remains free to comfort or stabilize the pet, thus improving practicality and ease of use.

Additional advantages and features of the invention will become apparent from the description which follows, and may be realized by means of the instrumentalities and combinations particularly pointing out in the appended claims.

According to the present invention, the foregoing and other objects and advantages are attained by a pet paw washing arrangement, comprising:

a washing cup having a washing chamber, a water outlet communicated to the washing chamber for spraying water into the washing chamber, an access opening communicated to the washing chamber for allowing the pet paw to enter the washing chamber; and

a water storage container which comprises a container body having a water chamber communicated to the water outlet to supply water to the washing chamber for cleaning the pet paw and a wastewater chamber communicated to the washing chamber.

According to an embodiment, the pet paw washing arrangement further comprises a water feeding pipeline which has a water feeding channel communicated between the water chamber and the water outlet and a wastewater channel communicated between the washing chamber and the wastewater chamber.

According to an embodiment, the washing cup comprises a bottom wall and a surrounding wall connected to the bottom wall to define the washing chamber, wherein the water outlet is formed in the surrounding wall of the washing cup.

According to an embodiment, the washing cup has a wastewater inlet formed in the bottom wall thereof for communicating with the wastewater channel.

According to an embodiment, the container body comprises a flexible partition layer which is disposed between the water chamber and the wastewater chamber.

According to an embodiment, the wastewater chamber is formed within the flexible partition layer.

According to an embodiment, the surrounding wall is made of a flexible material.

According to an embodiment, the washing cup comprises a plurality of brush elements protruded from the surrounding wall and extended into the washing chamber.

According to an embodiment, the plurality of brush element are arranged around the water outlet.

According to an embodiment, the washing cup comprises a plurality of brush elements protruded from the surrounding wall and extended into the washing chamber, wherein the plurality of brush element are arranged around the water outlet, each of the plurality of brush elements is made of silicon material.

According to an embodiment, a water guiding element is connected between the washing cup and the water feeding pipeline for supplying water from the water feeding pipeline to the washing cup.

According to an embodiment, the water guiding element is made of a material more rigid than the water feeding pipeline.

According to an embodiment, the water guiding element comprises a water guiding component having a water guiding channel communicated to the water outlet, wherein the water guiding component is vertically extended from the surrounding wall of the washing cup.

According to an embodiment, the water guiding element further comprises a connection component connected between the water guiding component and the water feeding pipeline, wherein the connection component has a water communication channel communicated the the water guiding channel.

According to an embodiment, the connection component is curvedly extended between the water guiding component and the water feeding pipeline, wherein a holding channel is defined between the surrounding wall of the washing cup and the water guiding element.

According to an embodiment, a holding strip is connected to the surrounding wall of the washing cup to define a holding passage between the holding strip and the surrounding wall of the washing cup.

According to an embodiment, the water storage container comprises a water pump for pumping water from the container body to the washing cup, and a power module electrically connected to the water pump, wherein an electric switch assembly which is operatively coupled to the water pump and is disposed on the water guiding element for allowing a single hand of the user to carry out a rinse operation by the washing cup and a control operation by the electric switch assembly.

According to an embodiment, the electric switch assembly comprises a flexible cover, an electric switch member, and two electrical connection wires electrically connected to the electric switch member, wherein the electric switch member is installed in the water guiding element and the flexible cover is disposed on the electric switch member at a top of the water guiding element.

According to an embodiment, the water guiding element has an installation chamber for installing the electric switch member and has a wire channel communicated to the installation chamber for receiving the two electrical connection wires.

According to an embodiment, the water feeding pipeline has a water feeding channel communicated between the container body and the water guiding channel and an internal wire passage communicated to the wire channel of the water guiding element for installing the two electrical connection wires, so that the two electrical connection wires are electrically coupled to the water pump, wherein the flexible cover is provided at a top of the water guiding element.

### BRIEF DESCRIPTION OF THE DRAWINGS

FIG. 1 is a perspective view of a pet paw washing arrangement according to a preferred embodiment of the present invention.

FIG. 2 is another perspective view of the pet paw washing arrangement according to the above preferred embodiment of the present invention.

FIG. 3 is a top schematic view of the pet paw washing arrangement according to the above preferred embodiment of the present invention.

FIG. 4 is a schematic view of the pet paw washing arrangement which is cut along a plane A-A.

FIG. 5 is a schematic view of the pet paw washing arrangement which is cut along a plane B-B.

FIG. 6 is a schematic view of the pet paw washing arrangement which is cut along a plane C-C.

FIG. 7 is a schematic view of the pet paw washing arrangement which is cut along a plane D-D.

FIG. 8 is a schematic view of a pet washing device of the pet paw washing arrangement according to the above preferred embodiment of the present invention.

FIG. 9 is an exploded view of the pet paw washing arrangement according to the above preferred embodiment of the present invention.

FIG. 10 is an exploded view of the pet washing device of the pet paw washing arrangement according to the above preferred embodiment of the present invention.

FIG. 11 is another exploded view of the pet washing device of the pet paw washing arrangement according to the above preferred embodiment of the present invention.

FIG. 12 is an exploded view of a water storage container of the pet paw washing arrangement according to the above preferred embodiment of the present invention.

FIG. 13 is another exploded view of a water storage container of the pet paw washing arrangement according to the above preferred embodiment of the present invention.

FIG. 14 is a perspective view of the water storage container of the pet paw washing arrangement according to the above preferred embodiment of the present invention.

FIG. 15 is another perspective view of the water storage container of the pet paw washing arrangement according to the above preferred embodiment of the present invention.

FIGS. 16 and 17 are perspective views illustrating a water feeding inlet and a wastewater discharge outlet of the water storage container of the pet paw washing arrangement according to the above preferred embodiment of the present invention.

FIG. 18 is a perspective view illustrating a water pump of the water storage container of the pet paw washing arrangement according to the above preferred embodiment of the present invention.

FIG. 19 is a schematic view illustrating a water chamber and a wastewater chamber of the water storage container of the pet paw washing arrangement according to the above preferred embodiment of the present invention.

FIG. 20 is a schematic view illustrating a water feeding pipeline of the pet paw washing arrangement according to the above preferred embodiment of the present invention.

FIG. 21 is a schematic view illustrating the pet paw washing arrangement being used for pet paw washing according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

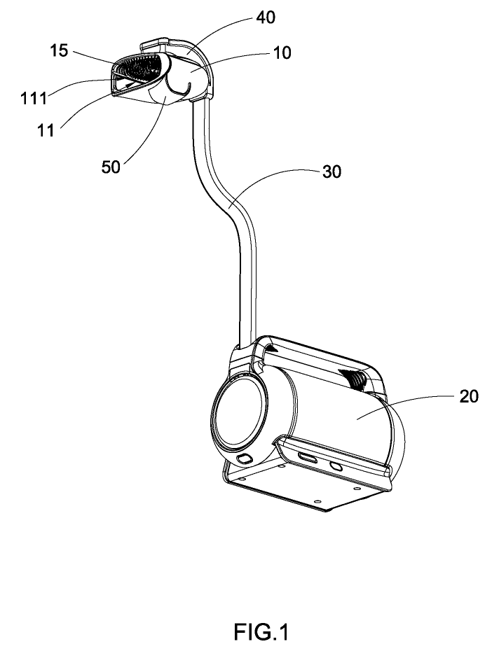

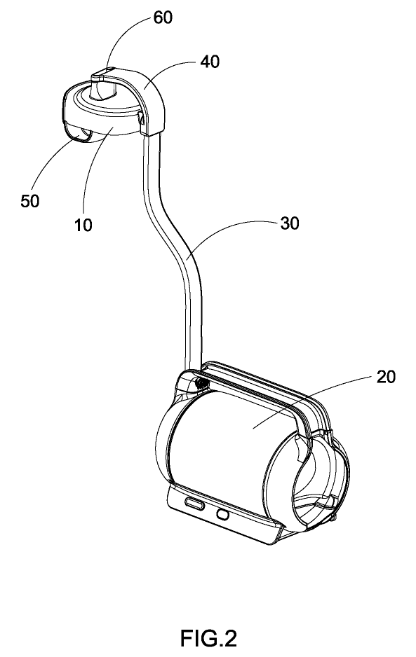

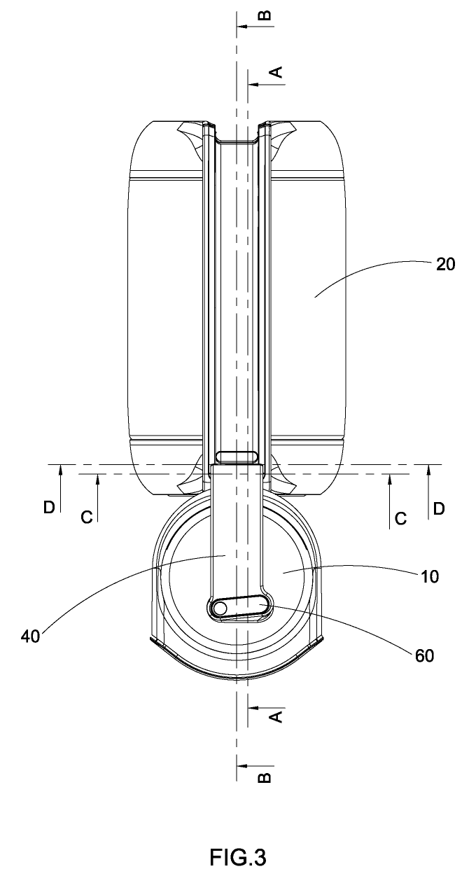

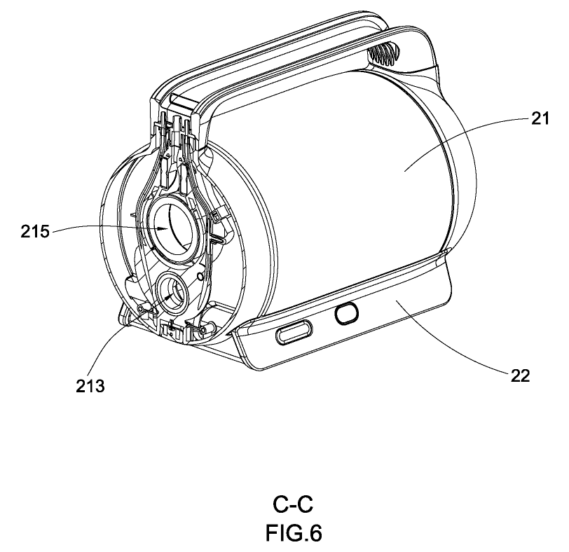

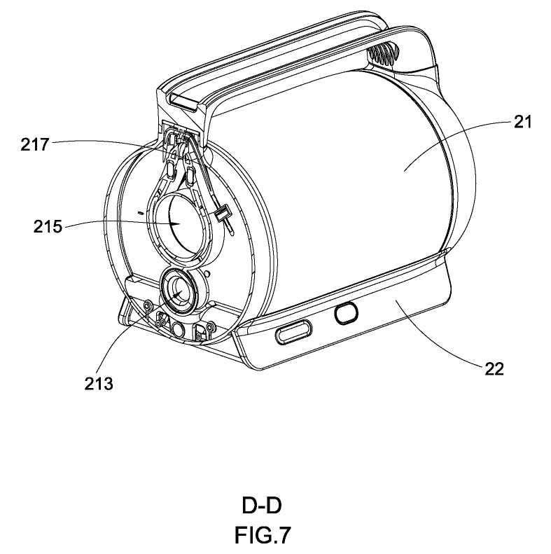

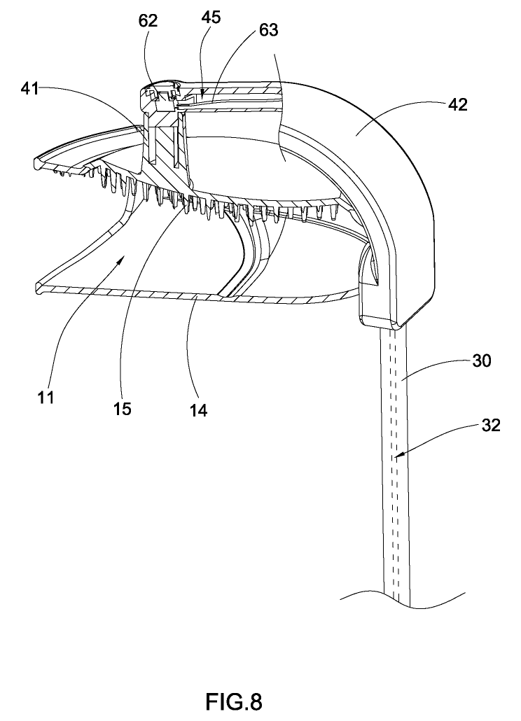

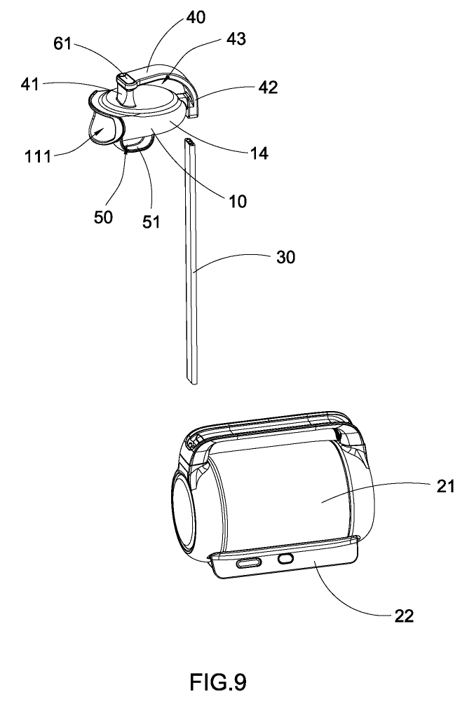

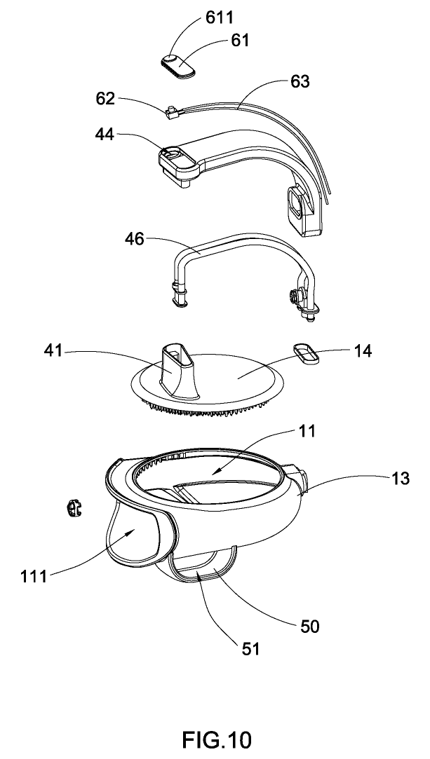

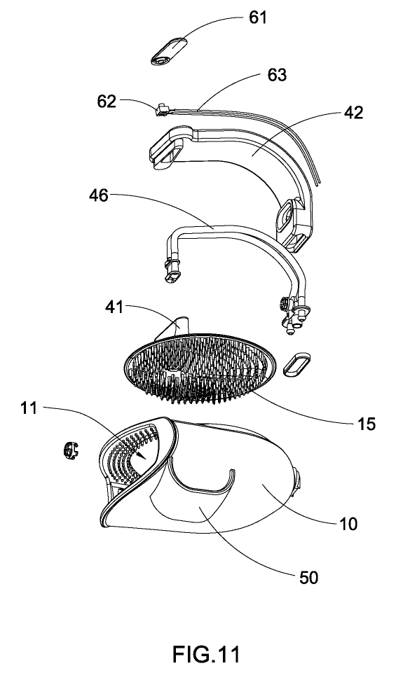

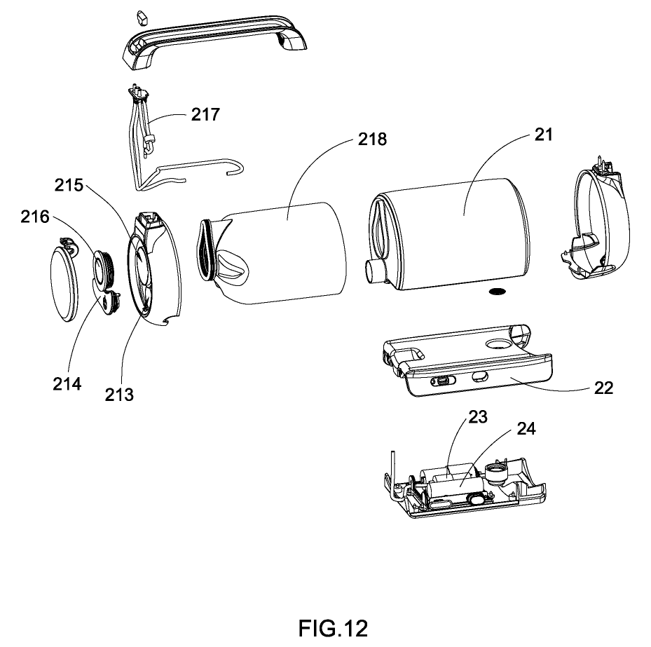

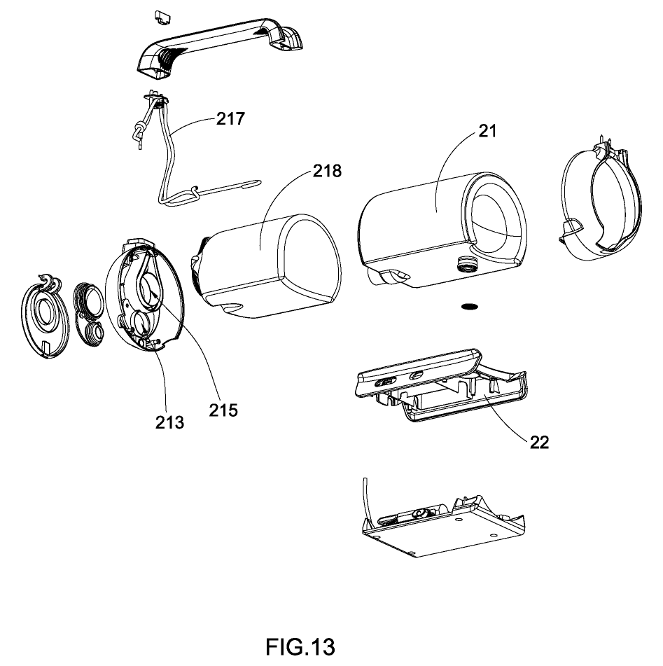

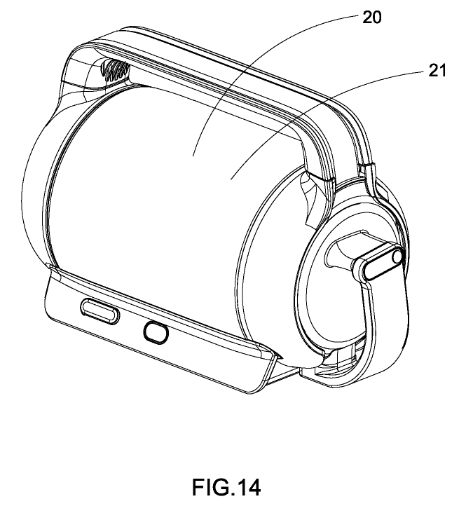

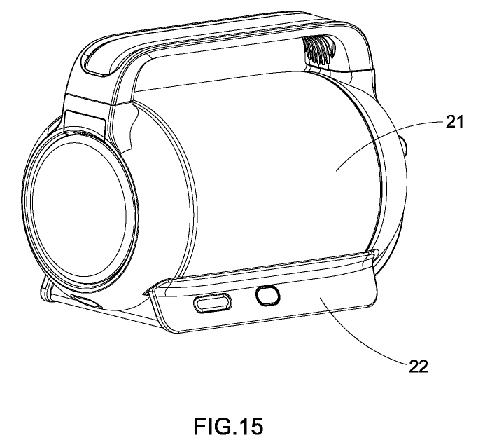

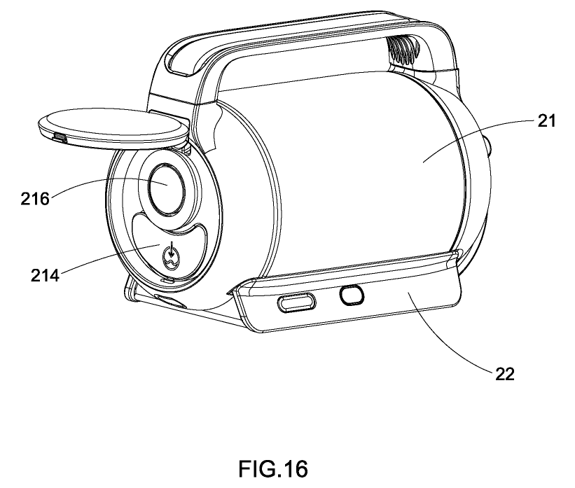

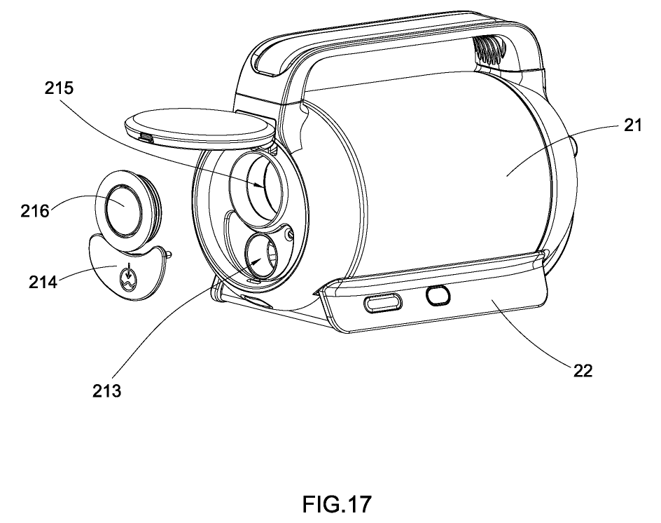

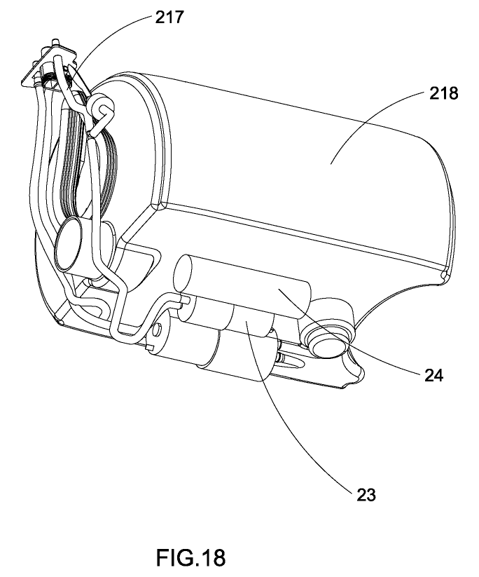

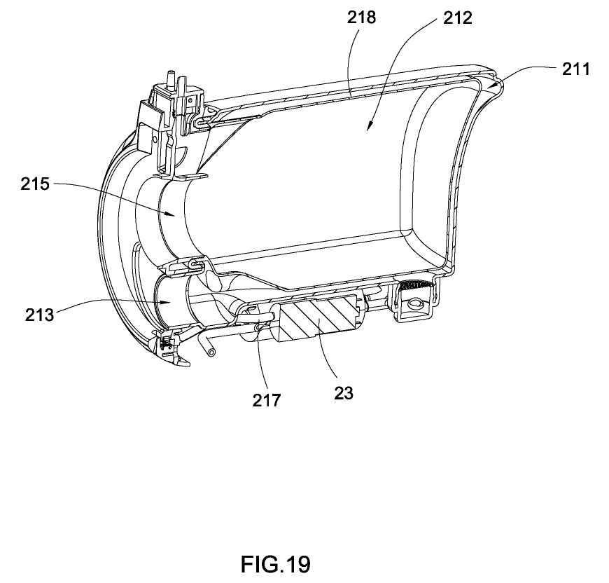

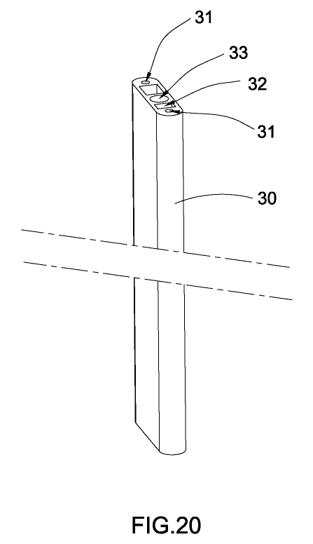

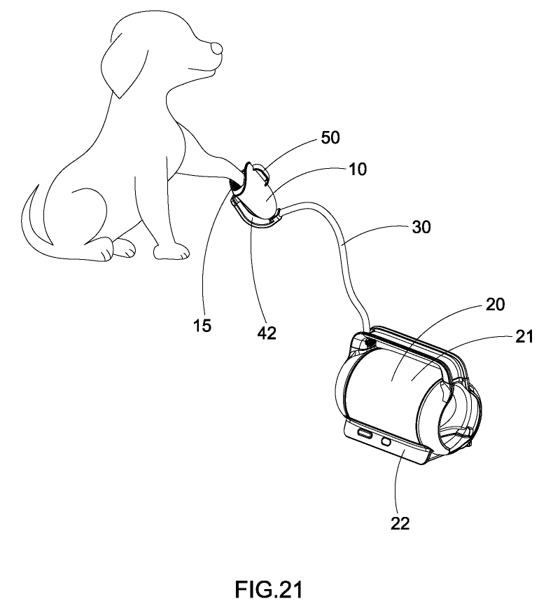

Referring to FIGS. 1 to 21 of the drawings, a pet paw washing arrangement according to a preferred embodiment of the present invention is illustrated, the pet paw washing arrangement comprises a pet washing device and a water storage container 20 connected to the pet washing device for supplying water to the pet washing device.

In this embodiment, the pet washing device is embodied as a washing cup 10 having a washing chamber 11 and a water outlet 12 communicated to the washing chamber 11. The water storage container 20 is arranged to supply water to the water outlet 12, so as to direct water into the washing chamber 11 for washing the pet paw disposed in the washing chamber 11.

Accordingly, in operation, when the pet paw is inserted into the washing chamber 11 through an access opening 111 of the washing chamber 11, the water delivered from the water storage container 20 flows through the water outlet 12 to rinse, flush, and wash debris, dirt, and mud from the paw. Unlike conventional paw-washing cups that rely on stagnant water, the connection with the water storage container 20 ensures that each washing operation uses a flow of clean water. This improves hygiene and prevents cross-contamination when cleaning multiple paws.

The water outlet 12 continually directs water precisely into the washing chamber 11, thereby increasing rinsing efficiency. Because clean water is always supplied from the water storage container 20, the user can sequentially wash all the paws of the pet without the need to change water after each paw. This reduces inconvenience and speeds up the overall cleaning process.

The washing cup 10 allows the pet paw to be inserted without immersing the entire leg. Since water is only delivered into the washing chamber 11 during the cleaning process, pets experience less discomfort and stress compared to fully immersing their paw in a static water container.

The water storage container 20 can be configured as a portable tank, flexible bag, or pressurizable container, making the entire arrangement suitable for outdoor use, such as after a walk, before entering a vehicle, or at the entrance of a home.

More specifically, the washing cup 10 comprises a bottom wall 13 and a surrounding wall 14 extended from the bottom wall 13 to define the washing chamber 11, the water outlet 12 is formed in the surrounding wall 14, so as to that water is supplied laterally from the side wall into the washing chamber 11. In this way, the water stream enters the washing chamber 11 from the side and circulates around the pet paw, ensuring that the paw is rinsed not only from below but also from the lateral directions, thereby achieving a more comprehensive washing effect.

By delivering water laterally into the washing chamber 11, the flow can surround the paw from the side, flushing dirt out of gaps between claws more effectively than bottom-only rinsing.

In this embodiment, when the pet paw is inserted into the washing chamber 11, the water outlet 12 is not directed toward the distal end of the paw but is instead oriented toward the underside of the pet paw. In this manner, the water flow is directly ejected onto the paw’s bottom surface, where mud, dust, and debris are most likely to accumulate. By targeting the underside of the paw with a direct flushing stream, dirt trapped between the paw pads and claws can be more effectively dislodged and rinsed away.

In addition, since the pet paw is inserted into the washing chamber 11 of the washing cup 10 during cleaning, the water flow supplied from the water outlet 12 is confined within the washing chamber 11. As a result, the water does not freely splash outward during use. In particular, the structure of the washing cup 10 prevents water from splashing onto the user’s hands, body, or clothing, thereby keeping the cleaning process neat and comfortable.

The washing cup 10 further comprises a plurality of flexible brush elements 15 provided on the inner side of the surrounding wall 14 and extended into the washing chamber 11, the flexible brush elements 15 can be bristles or silicone protrusions which cooperate with the water flow to scrub the paw surface, enabling more effective cleaning of the areas between paw pads and claws.

In addition, the surrounding wall 14 of the washing cup 10 is made of a flexible material. Preferably, the entire washing cup 10 is made of a flexible material. This flexibility allows the user to gently squeeze or guide the surrounding wall 14 during use, so that the brush elements 15 inside the washing chamber 11 come into closer contact with the pet paw. As a result, the pet paw washing arrangement can be used to perform a simultaneous washing and scrubbing action, while water continuously rinses the paw through the water outlet 12, the brush elements 15 can be rubbed against the paw surface to dislodge stubborn dirt and mud.

Preferably, the plurality of flexible brush elements 15 are located around the water outlet 12. In this manner, when water is supplied through the water outlet 12 into the washing chamber 11, the water flow cooperates with the surrounding brush elements 15 to directly scrub and rinse the paw surface. This arrangement allows the water jet to flush debris away while the brush elements 15 simultaneously contact the underside and adjacent areas of the pet paw, achieving a more comprehensive cleaning effect.

The pet paw washing arrangement further comprises a water feeding pipeline 30 communicated to the water storage container 20, the water feeding pipeline 30 has at least one water feeding channel 31 which is communicated between the water storage container 20 and the washing cup 10.

The water storage container 20 is a container that can store water, which can be a water storage tank made of rigid materials such as plastic or metal, or mainly a water storage bag made of flexible materials. In this illustrated embodiment, the water storage container 20 comprises a container body 21 which can be implemented as a flexible water storage bag for easy storage and transportation. It should be understood that the water stored in the container body 21 of the water storage container 20 can be clean pure water or water with an added cleaning agent.

The water storage container 20 further comprises a bottom shell 22, a water pump 23, and a power module 24. The power module 24 can comprise a rechargeable battery and is electrically connected to the water pump 23. The water pump 23 and the power module 24 are installed in the bottom shell 22, and the bottom shell 22 is connected to the container body 21 to serve as a base for the water storage container 20. When the water pump 23 is turned on, it can pump water from the container body 21 into the water feeding pipeline 30, and then deliver the water to the water outlet 12 through the water feeding pipeline 30, and water is sprayed out from the water outlet 12.

In this embodiment, the container body 21 has a water chamber 211 communicated to the water feeding channel 31 of the water feeding pipeline 30 and a wastewater chamber 212 which is not communicated to the water chamber 211. The water feeding pipeline 30 has a wastewater channel 33 which is communicated between the washing chamber 11 of the washing cup 10 and the wastewater chamber 212, so that when the washing water from the water chamber 211 is feed into the washing chamber 11 of the washing cup 10 through the water feeding channel 31 of the water feeding pipeline 30 for washing the pet paw, the washing water in the washing chamber 11 will enter the wastewater channel 33 of the water feeding pipeline 30 and collected in the wastewater chamber 212 of the container body 21.

It is can be understood that the wastewater channel 33 connected to the wastewater chamber 212 is functioning as a return channel. In an alternative mode, the wastewater chamber 212 may also be omitted that the wastewater channel 33 can be formed in a water drain pipe that can direct the wastewater in the washing cup 10 to a designated area.

In the present invention, the wastewater channel 33 directs the used water back into the wastewater chamber 212 instead of discharging it onto the ground, so as to prevent dirty water from polluting the floor or surrounding environment, making it suitable for use at home entrances, indoors, or in vehicle.

The washing cup 10 has a wastewater inlet 16 which is communicated to the wastewater channel 33. The wastewater inlet 16 is preferred to be formed in the bottom wall 13 of the washing cup 10. When the washing cup 10 is inclinedly or vertically held in the hand of the user, the water in the washing chamber 11 of the washing cup 10 will be easy to be directed into the wastewater channel 33 through the wastewater inlet 16 at the bottom of the washing cup 10.

In other words, the used washing water collected within the washing chamber 11 will naturally flow downward under gravity and be easily directed into the wastewater channel 33 through the wastewater inlet 16. By positioning the wastewater inlet 16 at the bottom wall 13, wastewater can flow out smoothly under gravity without requiring additional pumping or manual tilting, so as to reduce operational complexity and ensure continuous drainage during washing.

Because wastewater is immediately drained through the bottom inlet instead of accumulating in the washing chamber 11, debris, mud, and dirt are flushed away promptly, so as to prevent dirty water from lingering inside the washing cup 10, improving cleanliness and washing efficiency. The dedicated wastewater inlet 16 ensures that water exits in a controlled manner through the return channel 33 rather than overflowing at the access opening 111, the cleaning process is kept neat, avoids water splashing on the user, and prevents contamination of the surrounding area.

The container body 21 has a water feeding inlet 213 communicated to the water chamber 211 and comprises a first sealing lid 214 for sealing the water feeding inlet 213, thereby allowing the user to conveniently add clean water into the water chamber 211 while ensuring reliable sealing during use and transportation. The container body 21 further has a wastewater discharge outlet 215 communicated to the wastewater chamber 212 and comprises a second sealing lid 216 for sealing the wastewater discharge outlet 215. In this way, wastewater collected in the wastewater chamber 212 can be easily discharged after use, while the second sealing lid 216 ensures that no leakage occurs when the container body 21 is carried or stored.

The container body 21 further comprises one or more connecting tubes 217 which are connected to the water pump 23 and communicated to the water chamber 211 for directing water to the one or more water feeding channels 32 of the water feeding pipeline 30.

In this embodiment, the container body 21 further comprises a flexible partition layer 218 for forming the water chamber 211 and the wastewater chamber 212. During operation, when the clean water stored in the water chamber 211 is gradually delivered through the water feeding pipeline 30 into the washing cup 10, the volume of the water chamber 211 is correspondingly reduced. As the water chamber 211 decreases in size, the flexible partition layer 218 deforms accordingly. In response, the wastewater chamber 212 on the opposite side of the flexible partition layer 218 is enlarged, thereby creating additional space for storing the wastewater returned from the washing cup 10. In this manner, the flexible partition layer 218 dynamically adjusts the relative volumes of the water chamber 211 and the wastewater chamber 212, so that the total volume of the container body 21 remains substantially constant. The flexible partition layer 218 may be a middle sheet disposed in the container body 21, or is formed as a bladder and the wastewater chamber 212 is formed within the flexible partition layer 218.

In this embodiment, the pet paw washing arrangement further comprises a water guiding element 40 connected between the washing cup 10 and the water feeding pipeline 30 for supplying the water from the water feeding pipeline 30 to the washing cup 10.

In this embodiment, the water guiding element 40 comprises a water guiding component 41 having a water guiding channel 411 communicated to the water outlet 12. Preferably, the water guiding component 41 is vertically extended from the surrounding wall 14 of the washing cup 10, so that the water guiding component 41 has firm mechanical support from the wall of the washing cup 10, and it reduces wobbling or misalignment of the water outlet 12, increasing durability under repeated use. In addition, the water flow is discharged substantially perpendicular to the surrounding wall 14 of the washing cup 10, which reduces flow resistance, maintains higher outlet pressure, and ensures that the water stream is directed accurately toward the cleaning area, thereby improving the rinsing efficiency and reducing water scattering.

The water guiding element 40 further comprises a connection component 42 connected between the water guiding component 41 and the water feeding pipeline 30, the connection component 42 has a water communication channel 421 communicated to the water guiding channel 411. The water guiding channel 411 and the water communication channel 421 can be respectively formed by inner walls of the water guiding component 41 and the connection component 42. In this embodiment, as shown in the drawings, the water guiding channel 411 and the water communication channel 421 are formed in one or more water passage tubes 46.

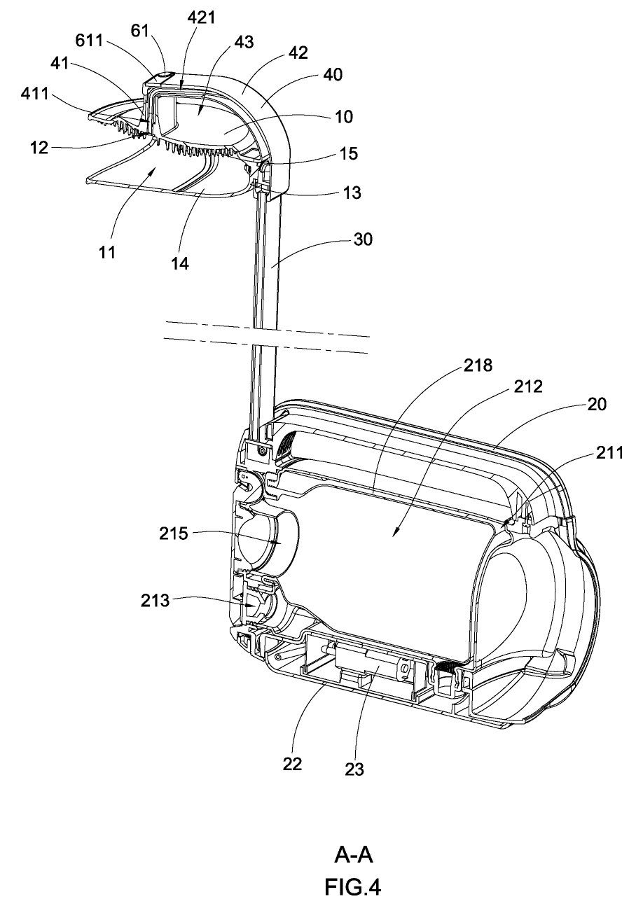

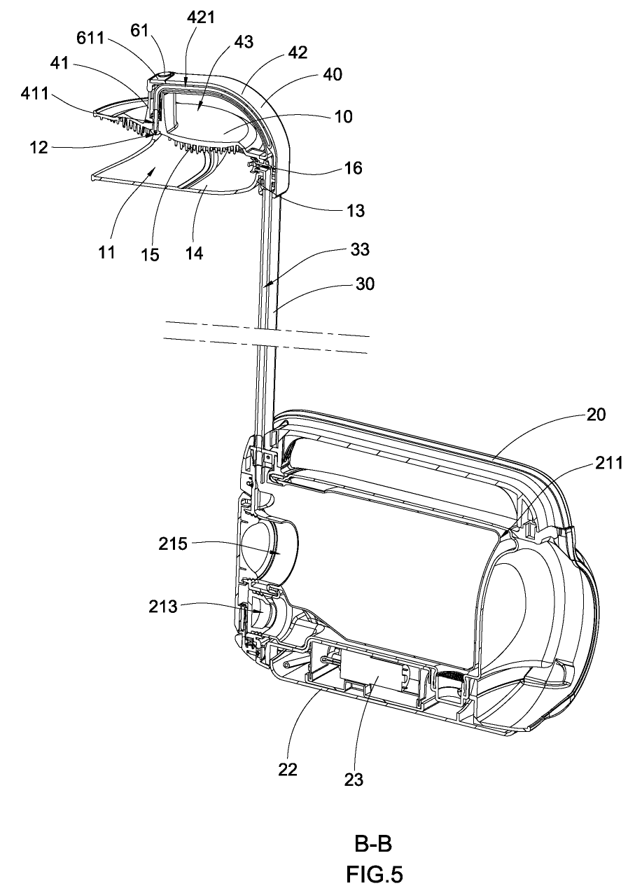

As shown in FIGS. 4 and 5 of the drawings, the connection component 42 is curvedly extended between the water guiding component 41 and the water feeding pipeline 43, and a holding channel 43 is defined between the surrounding wall 14 of the washing cup 10 and the water guiding element 40 for the placement of the fingers of the user.

The curved connection component 42 forms a natural recess along the outer side of the washing cup, so as to provides a comfortable and secure position for the user’s fingers when holding or wearing the washing cup 10, thereby enhancing grip stability. By placing the fingers within the holding channel 43, the user can effectively stabilize the washing cup while performing rinsing operations.

The fingers of the user may hold on the washing cup 10 with one or more fingers placed in the holding channel 43. The water guiding element 40 can be embodied to form by a plastic material which has is more rigid than the flexible material of the water feeding pipeline 30, and the fingers of the user may hold on the connection component 42 for carrying out the rinsing operation.

In this embodiment, the pet paw washing arrangement further comprises a holding strip 50 connected to the surrounding wall 14 of the washing cup 10 to define a holding passage 51 between the holding strip 50 and the surrounding wall 14 of the washing cup 10 for the placement of the fingers of the user. The holding strip 50 and the water guiding element 40 are connected to two sides of the washing cup 10, the holding channel 43 and the holding passage 51 are thus formed at two sides of the washing cup 10 for accommodating different fingers of the user. As an example, the thumb of the user is placed in the holding passage 51 while one or more rest fingers are placed in the holding channel 43, thereby allowing the user to securely grip the washing cup 10 during paw rinsing.

The configuration of the holding strip 50 and water guiding element 40 on opposite sides of the washing cup creates a hand-hold similar to gripping a handle, so as to provide a balanced force distribution and reduces hand fatigue during extended cleaning. With this gripping arrangement, the user’s fingers can simultaneously press against the flexible surrounding wall 14 of the washing cup 10 while holding the washing cup 10. By pressing or squeezing the flexible wall, the fingers can deform the wall to drive or guide the brush elements 15 disposed on the inner surface of the washing cup 10 to perform a scrubbing action on the paw of the pet. In this way, the gripping function and the scrubbing function are integrated into a single hand operation.

In this embodiment, the pet paw washing arrangement further comprises an electric switch assembly 60 which comprises a flexible cover 61, an electric switch member 62, and two electrical connection wires 63 electrically connected to the electric switch member 62. The flexible cover 61 and the electric switch member 62 are installed in the water guiding element 40. More specifically, the water guiding element 40 has an installation chamber 44 for installing the electric switch member 62 and the flexible cover 61 is placed above the electric switch member 62. The water guiding element 40 further has a wire channel 45 communicated to the installation chamber 44 for receiving the two electrical connection wires 63.

The water feeding pipeline 30 has the water feeding channel 31 communicated between the container body 21 and a water passage formed by the water guiding channel 411 and the water communication channel 421 of the water guiding element 40. In this embodiment, the water feeding pipeline 30 further has an internal wire passage 32 for installing the two electrical connection wires 63, so that the two electrical connection wires 63 are electrically coupled to the water pump 23 in the water storage container 20. Accordingly, the wire passage 32 of the water feeding pipeline 30 is communicated to the wire channel 45 of the water guiding element 40.

The flexible cover 61 comprises a pressing portion 611 at a position corresponding to the electric switch member 62 for a user to press thereon for controlling the operations of the electric switch member 62. The flexible cover 61 with the pressing portion 611 is preferred to be placed at a top of the water guiding element 40. A finger of the holding hand of the washing cup 411 which is not placed in the holding channel 43 can be used to press the pressing portion 611 for control the operation of the electric switch member 62, such as turn on the water pump 23, turn off the water pump 23, or adjust the power of the water pump 23. In other words, a single holding hand of the user is able to carry out the rinsing operation and the control.

It should be noted that, in the apparatus and method of the present application, each component or each step in different embodiments can be decomposed and/or recombined without departing from the principle of the present invention. These disassembly and/or recombination should be regarded as being included in the inventive concept of the present application.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and are subject to change without departure from such principles. Therefore, this invention comprises all modifications encompassed within the spirit and scope of the following claims.

What is claimed is:

1. A pet paw washing arrangement, comprising:
a washing cup having a washing chamber, a water outlet communicated to said washing chamber for spraying water into said washing chamber, an access opening communicated to said washing chamber for allowing the pet paw to enter said washing chamber; and
a water storage container which comprises a container body having a water chamber communicated to said water outlet to supply water to said washing chamber for cleaning the pet paw and a wastewater chamber communicated to said washing chamber.

2. The pet paw washing arrangement according to claim 1, further comprising a water feeding pipeline which has a water feeding channel communicated between said water chamber and said water outlet and a wastewater channel communicated between said washing chamber and said wastewater chamber.

3. The pet paw washing arrangement according to claim 2, wherein said washing cup comprises a bottom wall and a surrounding wall connected to said bottom wall to define said washing chamber, wherein said water outlet is formed in said surrounding wall of said washing cup.

4. The pet paw washing arrangement according to claim 3, wherein said washing cup has a wastewater inlet formed in said bottom wall thereof for communicating with said wastewater channel.

5. The pet paw washing arrangement according to claim 1, wherein said container body comprises a flexible partition layer which is disposed between said water chamber and said wastewater chamber.

6. The pet paw washing arrangement according to claim 5, wherein said wastewater chamber is formed within said flexible partition layer.

7. The pet paw washing arrangement according to claim 3, wherein said surrounding wall is made of a flexible material.

8. The pet paw washing arrangement according to claim 3, wherein said washing cup comprises a plurality of brush elements protruded from the surrounding wall and extended into said washing chamber.

9. The pet paw washing arrangement according to claim 8, wherein said plurality of brush element are arranged around said water outlet.

10. The pet paw washing arrangement according to claim 3, wherein said washing cup comprises a plurality of brush elements protruded from the surrounding wall and extended into said washing chamber, wherein said plurality of brush element are arranged around said water outlet, each of said plurality of brush elements is made of silicon material.

11. The pet paw washing arrangement according to claim 3, further comprising a water guiding element connected between said washing cup and said water feeding pipeline for supplying water from said water feeding pipeline to said washing cup.

12. The pet paw washing arrangement according to claim 11, wherein said water guiding element is made of a material more rigid than said water feeding pipeline.

13. The pet paw washing arrangement according to claim 11, wherein said water guiding element comprises a water guiding component having a water guiding channel communicated to said water outlet, wherein said water guiding component is vertically extended from said surrounding wall of said washing cup.

14. The pet paw washing arrangement according to claim 13, wherein said water guiding element further comprises a connection component connected between said water guiding component and said water feeding pipeline, wherein said connection component has a water communication channel communicated said the water guiding channel.

15. The pet paw washing arrangement according to claim 14, wherein said connection component is curvedly extended between said water guiding component and said water feeding pipeline, wherein a holding channel is defined between said surrounding wall of said washing cup and said water guiding element.

16. The pet paw washing arrangement according to claim 15, further comprising a holding strip connected to said surrounding wall of said washing cup to define a holding passage between said holding strip and said surrounding wall of said washing cup.

17. The pet paw washing arrangement according to claim 11, wherein said water storage container comprises a water pump for pumping water from said container body to said washing cup, and a power module electrically connected to said water pump, wherein an electric switch assembly which is operatively coupled to said water pump and is disposed on said water guiding element for allowing a single hand of the user to carry out a rinse operation by said washing cup and a control operation by said electric switch assembly.

18. The pet paw washing arrangement according to claim 17, wherein said electric switch assembly comprises a flexible cover, an electric switch member, and two electrical connection wires electrically connected to said electric switch member, wherein said electric switch member is installed in said water guiding element and said flexible cover is disposed on said electric switch member at a top of said water guiding element.

19. The pet paw washing arrangement according to claim 18, wherein said water guiding element has an installation chamber for installing said electric switch member and has a wire channel communicated to said installation chamber for receiving said two electrical connection wires.

20. The pet paw washing arrangement according to claim 19, wherein said water feeding pipeline has a water feeding channel communicated between said container body and said water guiding channel and an internal wire passage communicated to said wire channel of said water guiding element for installing said two electrical connection wires, so that said two electrical connection wires are electrically coupled to said water pump, wherein said flexible cover is provided at a top of said water guiding element.

21. A pet paw washing arrangement, comprising:
a washing cup having a washing chamber, a water outlet communicated to said washing chamber for spraying water into said washing chamber, an access opening communicated to said washing chamber for allowing the pet paw to enter said washing chamber;
a water storage container which comprises a container body having a water chamber communicated to said water outlet to supply water to said washing chamber for cleaning the pet paw; and
a wastewater channel communicated to said washing chamber for draining wastewater in said washing chamber.
